(19) United States
(12) Patent Application Publication
(10) Pub. No.: US 2009/0197989 A1
(43) Pub. Date: Aug. 6, 2009

(54) COMPOSITION COMPRISING CORE-SHELL PARTICLES AND ITS PREPARATION

(75) Inventor: Jochen Ebenhoch, Seoul (KR)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/576,102

(22) PCT Filed: Sep. 29, 2005
(86) PCT No.: PCT/EP05/10542

§ 371 Date: Mar. 27, 2007

(30) Foreign Application Priority Data
Sep. 30, 2004 (DE) 10 2004 047 708.6

(51) Int. Cl. C08L 83/06

(52) U.S. Cl. 523/201; 525/477

(57) ABSTRACT

A composition comprising core-shell particles having an organopolysiloxane core and a crosslinked or non-crosslinked organopolymer shell and one or more reactive resins. In some variations, the composition has a crosslinked or non-crosslinked organopolymer core. Additional different siloxane-containing particles are optionally included.

The invention relates to a composition comprising core-shell particles, and also to a process for its preparation.

EP 0266513 B1 describes modified reactive resins, processes for their preparation, and their use. It is restricted to compositions which comprise, alongside a reactive resin, at most from 2-50% by weight of three-dimensionally-crosslinked polyorganosiloxane rubbers, which have particle sizes of from 0.01 to 50 micrometers, in amounts of from 2-50% by weight, and the properties of the composition described in that specification are unsatisfactory in terms of impact strength and impact toughness.

It is an object of the invention to improve the prior art and to provide a composition with improved impact-strength and impact-toughness properties.

The invention provides a composition comprising (A) core-shell particles composed of an organopolysiloxane core which have a crosslinked or non-crosslinked organopolymer shell, and, if appropriate, have a crosslinked or non-crosslinked organopolymer core, or mixtures of these with any desired other siloxane-containing particles, and (B) a reactive resin or a mixture composed of various reactive resins.

The silicone particles are preferably elastomeric particulate copolymers with core-shell structure, composed of a core a) composed of an organosilicon polymer and of an organopolymeric shell c) or of two shells b) and c), or of a shell and of an inner core,

where the inner shell b) is composed of an organosilicon polymer, and where the copolymer is composed of
a) from 0.05 to 95% by weight, based on the total weight of the copolymer, of a core polymer of the general formulae
from 0-10 units of the general formula

[R₃SiO_{1/2}] (1),
from 0-90 units of the general formula

[R₂SiO_{2/2}] (2),
from 0-100 units of the general formula

[RSiO_{3/2}] (3),
from 0-50 units of the general formula

[SiO_{4/2}] (4),

where the units (2) and (3) together preferably amount to at least 5% by weight, based on the silicone content,
b) from 0 to 94.5% by weight, based on the total weight of the copolymer, of a polysiloxane shell of the general formulae
0-10 units of the general formula

[R₃SiO_{1/2}] (1),
0-90 units of the general formula

[R₂SiO_{2/2}] (2),
0-100 units of the general formula

[RSiO_{3/2}] (3),
0-50 units of the general formula

[SiO_{4/2}] (4),

c) from 5 to 95% by weight, based on the total weight of the copolymer, of a shell or of an inner core composed of organopolymer of mono- or polyolefinically unsaturated monomers,
where R is hydrogen atoms or identical or different monovalent SiC-bonded, if appropriate substituted, C₁-C₁₈-hydrocarbon radicals, and the size of the particles is from 10 to 400 nm, and the particles have a monomodal particle size distribution with a polydispersity index of at most σ₂=0.2.

Particulate copolymers composed of a core a) and of a shell c) are preferably composed of:

a) from 5 to 95% by weight, particularly preferably from 20 to 80% by weight, based on the total weight of the copolymer, of a core polymer (R₂SiO_{2/2})ₓ.(RSiO_{3/2})_{y}. (SiO_{4/2})_{z}, where x=from 10 to 99.5 mol %, in particular from 50 to 99 mol %; y=from 0.5 to 95 mol %, in particular from 1 to 50 mol %; z=from 0 to 30 mol %, in particular from 0 to 20 mol %; and
c) from 5 to 95% by weight, particularly preferably from 20 to 80% by weight, based on the total weight of the copolymer, of a shell composed of organopolymer of monoolefinically unsaturated monomers,
where R is identical or different monovalent alkyl or alkenyl radicals having from 1 to 6 carbon atoms, aryl radicals, or substituted hydrocarbon radicals.

Particulate copolymers composed of a core a), of an inner shell b), and of a shell c) are preferably composed of:

a) from 0.05 to 90% by weight, particularly preferably from 0.1 to 35% by weight, based on the total weight of the copolymer, of a core polymer (R′SiO_{3/2})_{y}.(SiO_{4/2})_{z}, where y=from 50 to 100 mol % and z=from 0 to 50 mol %, in particular from 0 to 30 mol %,
b) from 0.5 to 94.5% by weight, particularly preferably from 35 to 70% by weight, based on the total weight of the copolymer, of a polydialkylsiloxane shell composed of (R′₂SiO_{2/2})ₙ units,
c) from 5 to 95% by weight, particularly preferably from 30 to 70% by weight, based on the total weight of the copolymer, of a shell composed of organopolymer of monoolefinically unsaturated monomers,
where R′ is preferably identical or different monovalent alkyl or alkenyl radicals having from 1 to 18 carbon atoms, preferably from 1 to 6 carbon atoms, aryl radicals, or substituted hydrocarbon radicals.

The radicals R′ are preferably alkyl radicals, such as the methyl, ethyl, n-propyl, isopropyl, n-butyl, sec-butyl, amyl, hexyl radical; alkenyl radicals, such as the vinyl and allyl radical, and the butenyl radical; aryl radicals, such as the phenyl radical; or substituted hydrocarbon radicals. Examples of these are halogenated hydrocarbon radicals, such as the chloromethyl, 3-chloropropyl, 3-bromopropyl, 3,3,3-trifluoropropyl, and 5,5,5,4,4,3,3-heptafluoropentyl radical, and also the chlorophenyl radical; mercaptoalkyl radicals, such as the 2-mercaptoethyl and 3-mercaptopropyl radical; cyanoalkyl radicals, such as the 2-cyanoethyl and 3-cyanopropyl radical; aminoalkyl radicals, such as the 3-aminopropyl radical; acryloxyalkyl radicals, such as the 3-acryloxypropyl and 3-methacryloxypropyl radical; hydroxyalkyl radicals, such as the hydroxypropyl radical.

Particular preference is given to the radicals methyl, ethyl, propyl, phenyl, vinyl, 3-methacryloxypropyl, and 3-mercaptopropyl, where less than 30 mol % of the radicals in the siloxane polymer are vinyl, 3-methacryloxypropyl, or 3-mercaptopropyl groups.

The organosilicon shell polymer b) is preferably composed of dialkylsiloxane units (R′₂SiO_{2/2}), where R′ is methyl or ethyl.

Monomers preferably used for the organic polymer content c) are acrylic esters or methacrylic esters of aliphatic alcohols having from 1 to 10 carbon atoms, acrylonitrile, styrene, p-methylstyrene, α-methylstyrene, vinyl acetate, vinyl propionate, maleimide, vinyl chloride, ethylene, butadiene, isoprene, and chloroprene. Particular preference is given to styrene, and also to acrylic esters and methacrylic esters of aliphatic alcohols having from 1 to 4 carbon atoms, e.g. methyl (meth)acrylate, ethyl (meth)acrylate, or butyl (meth)acrylate. Either homopolymers or copolymers of the monomers mentioned are suitable as organic polymer content.

The average particle size (diameter) of the fine-particle elastomeric graft copolymers is from 10 to 400 nm, preferably from 30 to 350 nm, measured with a transmission electron microscope. The particle size distribution is very uniform, and the graft copolymers are monomodal, i.e. the particles have a maximum in the particle size distribution and a polydispersity factor σ₂ of at most 0.2, measured by a transmission electron microscope.

The core-shell particles are preferably prepared as in EP 492 376 A2 (Wacker-Chemie GmbH) and examples therein.

The amounts of the core-shell particles present in the inventive composition are from 5 to 95% by weight, based on the total weight of the composition, preferably from 10 to 90% by weight, particularly preferably from 20 to 60% by weight.

The total content of all of the particles in the composition is from 5 to 95% by weight, based on the total weight of the composition, preferably from 5 to 90% by weight, and particularly preferably from 10 to 80% by weight.

The inventive compositions may comprise one or more types of different core-shell particles, these being as described above, these differing in their size or in their structure. The compositions preferably comprise at most 3 different types of core-shell particles.

The mixtures with any desired other siloxane-containing particles are those which, alongside the core-shell particles described above, also comprise one or more types of organopolysiloxane particles for example as described in EP 744 432 A.

The compositions preferably comprise at most 1 type of organopolysiloxane particles, as described above, and also, if appropriate, the particles described in EP 0 266 513 B1.

The core-shell particles in the inventive composition have a core and, if appropriate, therein an inner core, and a shell around the core, and the silicone content of the core-shell particles is preferably from 5 to 95% by weight, with preference from 10 to 90% by weight, particularly preferably from 20 to 90% by weight.

Particularly preferred core-shell particles comprise a core composed of at least 20% by weight of a crosslinked silicone core and a shell composed of at most 60% by weight of a grafted-on organopolymer. Particularly preferred organopolymers are polymers based on poly(alkyl) (meth)acrylates and on copolymers of these with other monomer units.

The compositions may comprise from 0.1 to 99.9% by weight of core-shell particles, preferably from 5.0 to 60% by weight, and particularly preferably from 10.0 to 50% by weight.

The average diameter of the core-shell particles in the inventive composition is preferably from 5 to 400 nm, with preference from 50 to 400 nm, particularly preferably from 80 to 350 nm.

The silicone content of the core-shell particles in the inventive composition is composed of organopolysiloxane composed of

from 0-10 units of the general formula

[R₃SiO_{1/2}] (1),
from 0-90 units of the general formula

[R₂SiO_{2/2}] (2),
from 0-100 units of the general formula

[RSiO_{3/2}] (3),
from 0-50 units of the general formula

[SiO_{4/2}] (4),

where the units (2) and (3) together preferably amount to at least 5% by weight, based on the silicone content, where
R is hydrogen atoms or identical or different monovalent SiC-bonded, if appropriate substituted C₁-C₁₈-hydrocarbon radicals.

Examples of unsubstituted radicals R are alkyl radicals, such as the methyl, ethyl, n-propyl, isopropyl, n-butyl, isobutyl, tert-butyl, n-pentyl, isopentyl, neopentyl or tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, octadecyl radicals, such as the n-octadecyl radical; alkenyl radicals, such as the vinyl, allyl, n-5-hexenyl, 4-vinylcyclohexyl, and 3-norbornenyl radical; cycloalkyl radicals, such as cyclopentyl, cyclohexyl, 4-ethylcyclohexyl and cycloheptyl radicals, norbornyl radicals, and methylcyclohexyl radicals; aryl radicals, such as the phenyl, biphenylyl, naphthyl and anthryl and phenanthryl radical; alkaryl radicals, such as o-, m-, p-tolyl radicals, xylyl radicals and ethylphenyl radicals; and aralkyl radicals, such as the benzyl radical and the α- and β-phenylethyl radical and also the fluorenyl radical.

Examples of substituted hydrocarbons as radical R are halogenated hydrocarbon radicals, such as the chloromethyl, 3-chloropropyl, 3-bromopropyl, 3,3,3-trifluoropropyl, and 5,5,5,4,4,3,3-heptafluoropentyl radical, and also the chlorophenyl, dichlorophenyl, and trifluorotolyl radical; mercaptoalkyl radicals, such as the 2-mercaptoethyl and 3-mercaptopropyl radical; cyanoalkyl radicals, such as the 2-cyanoethyl and 3-cyanopropyl radical; aminoalkyl radicals, such as the 3-aminopropyl, N-(2-aminoethyl)-3-aminopropyl, and N-(2-aminoethyl)-3-amino-(2-methyl)propyl radical; aminoaryl radicals, such as the aminophenyl radical; quaternary ammonium radicals; acryloxyalkyl radicals, such as the 3-acryloxypropyl and 3-methacryloxypropyl radical; hydroxyalkyl radicals, such as the hydroxypropyl radical; phosphonic acid radicals; phosphonate radicals and sulfonate radicals, such as the 2-diethoxyphosphonatoethyl or 3-sulfonatopropyl radical, dihydroxypropyl radical, hydroxyphenyl radical.

The radical R is preferably unsubstituted or substituted C₁-C₆-alkyl radicals, hydrogen, or the phenyl radical, in particular the methyl, phenyl, vinyl, allyl, methacryloxypropyl, 3-chloropropyl, 3-mercaptopropyl, 3-aminopropyl, or (2-aminoethyl)-3-aminopropyl radical, hydrogen, or quaternary ammonium radicals, or else the dihydroxypropyl radical, hydroxyphenyl radical, or hydroxypropyl radical.

According to the invention, suitable reactive resins are any of the polymeric or oligomeric organic compounds which have an adequate number of reactive groups suitable for a curing reaction. The mechanism by which crosslinking or curing proceeds in the specific instance here is of no great importance for the purposes of the invention. Suitable starting materials for preparing the inventive modified reactive resins are therefore generally any of the reactive resins which can be processed to give thermosets, irrespective of the particular mechanism by which crosslinking proceeds in the curing of the particular reactive resin.

The reactive resins that may be used as starting materials may in principle be divided into three groups, according to the type of crosslinking via addition, condensation, or polymerization.

From the first group of the reactive resins crosslinked via polyaddition, it is preferable to select one or more epoxy resins, urethane resins, and/or air-drying alkyd resins as starting material. Epoxy resins and urethane resins are usually cured via addition of stoichiometric amounts of a hardener containing hydroxy, amino, carboxy, or carboxylic anhydride groups, and the curing reaction here takes place via an addition reaction of the oxirane or isocyanate groups of the resin onto the appropriate groups of the hardener. In the case of epoxy resins, what is known as catalytic hardening is also possible, via polyaddition reactions of the oxirane groups themselves. Air-drying alkyd resins crosslink via autoxidation with atmospheric oxygen. Addition-hardening silicone resins are also known, preference being given to those which comprise no other free silanes.

Examples of the second group of reactive resins, crosslinked via polycondensation, are condensates of aldehydes, e.g. formaldehyde, with aliphatic or aromatic compounds containing amine groups, e.g. urea or melamine, or with aromatic compounds, such as phenol, resorcinol, kresol, xylene, etc., and other examples are furan resins, saturated polyester resins, and condensation-hardened silicone resins. The curing process here mostly takes place via a temperature increase with elimination of water, of low-molecular-weight alcohols, or of other low-molecular-weight compounds. Preferred starting material selected for the reactive resins modified according to the invention are one or more phenolic resins, resorcinol resins, and/or kresol resins, and specifically not only resols but also novolaks, and also urea, formaldehyde precondensates, melamine-formaldehyde precondensates, furan resins, and also saturated polyester resins, and/or silicone resins.

Preferred starting resins for the inventively modified reactive resins from the third group, of the reactive resins crosslinked via polymerization, are one or more homo- or copolymers of acrylic acid and/or methacrylic acid or esters thereof, or else unsaturated polyester resins, vinyl ester resins, and/or maleimide resins. These resins have polymerizable double bonds, the polymerization or copolymerization of which brings about the three-dimensional crosslinking process. Initiators used are compounds capable of forming free radicals, e.g. peroxides, peroxo compounds, or compounds containing azo groups. It is also possible to initiate the crosslinking reaction via high-energy radiation, such as UV radiation or an electron beam.

Materials which can be modified in the manner proposed according to the invention, and which, after crosslinking and hardening, give thermosets with considerably better fracture toughness and impact toughness, are not only the above-mentioned reactive resins but also any of the other resins suitable for preparation of thermoset plastics, and there is in essence no effect here on other substantive properties characteristic of thermosets, e.g. strength, heat resistance, and chemicals resistance. It is unimportant here whether the reactive resins are solid or liquid at room temperature. The molecular weight of the reactive resins is also practically insignificant.

Reactive resins may also include compounds often used as hardener components for reactive resins, e.g. phenolic resins or anhydride hardeners.

Reactive resins which may preferably be present in the inventive composition are: epoxy resins, such as bisphenol A diglycidyl ether, bisphenol F diglycidyl ether, novolak-epoxy resins, epoxy resins containing biphenyl units, aliphatic or cycloaliphatic epoxy resins, such as 3,4-epoxycyclohexylmethyl-3,4-epoxycyclohexanecarboxylate. All of the epoxy resins may deviate at least to some extent from the monomeric structure, as determined by the degree of condensation during preparation. It is also possible to use acrylate resins for the inventive compositions. Examples of preferred acrylate resins are triethylene glycol dimethacrylate, urethane dimethacrylate, glycidyl methacrylate. Other materials are phenolic resins, urethane resins, silicone resins, the latter preferably being those not containing any other free silanes.

By way of example, the inventive compositions may be prepared via dispersion of isolated core-shell particles in the reactive resin. In an example of this process, the reactive resin forms an initial charge, and the core-shell particles are incorporated by mixing at temperatures of from 20 to 250° C., and any of the known methods of dispersion may be used here. It is advantageous here to use shear energy during the dispersion process. The quality of the dispersion may be checked after hardening of the reactive resin, for example using electron microscopy.

The invention also provides a process for preparation of an inventive composition, where at least one reactive resin is added to an organic solution of the core-shell particles and, if appropriate, of other siloxane-containing particles, and the solvent is removed.

The solution of the core-shell particles is preferably prepared as in EP 100 32 820.

However, it can also be prepared by preparing a solution from the core-shell particles with a solvent. Examples of preferred materials are aliphatic or aromatic hydrocarbons, such as hexane, styrene, benzene, toluene, xylene, aliphatic or aromatic lactons, lactams, ketones, ketals, acetals, alcohols, thiols, amines, amides, esters, sulfones, or else low-molecular weight polyorganosiloxanes, such as hexamethyldisiloxane, octamethyltrisiloxane, or cyclooctamethyltetrasiloxane.

Particular preference is given to toluene, xylene, butyl acetate, ethyl acetate, methyl isobutyl ketone, methyl ethyl ketone, butyl methyl ether, and hexamethyldisiloxane. Mixtures of these compounds are also particularly preferred.

It is also possible for the core-shell particles to be modified chemically or physically after the preparation of the solution in the solvents mentioned. By way of example, polymer-analogous reactions, crosslinking reactions, hydrolysis reactions, or other reactions may be carried out after the preparation of the solution. It is also possible to form adducts or intercalates of organic, organometallic, or inorganic molecules, e.g. catalysts, cocatalysts, or dyes.

The mixture of solution and resin may take place in any desired sequence if there are two or more types of core-shell particles, and the mixing process preferably takes place at least 20° C. and not above the boiling point of the solvent.

If appropriate, further solvent may be added subsequently, after the mixing process. This can be advantageous if the intention is to drive off other undesirable components, e.g. water.

It is then possible to bring about reaction between the reactive resin and the core-shell particles, e.g. via simple heating, irradiation, or via addition of auxiliaries which promote a reaction. The result is modification of the core-shell particles by the reactive resin or modification of the reactive resin by the core-shell particles, and this can be advantageous.

The solvent is then removed in one or more stages; by way of example, the solvent may be removed by means of membrane filtration processes, using molecular sieves, via freezing, via washing, or via extraction or via drying. The solvent is preferably removed via drying, and this drying may take place at low temperatures in vacuo or at elevated temperatures, with or without vacuum. The drying is preferably carried out at relatively high temperatures, a process also known as distillation. The solvent may also be removed using a combination of two or more different methods, applied in succession.

The solvent is preferably removed by distillation in one or more steps. It can sometimes be necessary, prior to the distillation process, to add a stabilizer for the reactive resin, in order to prevent, or at least to suppress, any premature polymerization or crosslinking reaction.

It can be advantageous not to remove the solvent completely, if the solvent itself provides a reactive resin.

### EXAMPLES

### Example 1

1a) 500 g of an aqueous dispersion of core-shell particles of size 100 nm, which are composed of a silicone core and of a grafted-on acrylate copolymer shell, of narrow particle size distribution with solids content of 30% by weight is precipitated at room temperature, using 500 g of a 5% strength NaCl solution. The precipitated core-shell material is pressed to remove liquid and treated with 850 g of toluene to prepare an organosol, and dissolved over 24 hours at 60° C., with constant motion. The solution is cooled and filtered, and the solids content is determined (12.7% by weight). This solution is then treated with 250 g of a cycloaliphatic epoxy resin, and the solvent is removed by distillation at slightly reduced pressure. This gave a flowable, viscous, opalescent composition which comprised 34% by weight of core-shell particles.

1b) As in Example 1a, but core-shell particles with an average diameter of 380 nm were used. The amount of cycloaliphatic epoxy resin was adjusted so that the resultant composition comprised 10% by weight of core-shell particles in the resin.

### Example 2

As Example 1a, but, prior to the precipitation process, the aqueous dispersion of core-shell particles was treated with an aqueous dispersion as silicone elastomer particles which have a diameter of about 100 nm. The precipitated material comprised 40% by weight of silicone elastomer particles and 60% by weight of core-shell particles. The subsequent procedure was exactly as in Example 1a, except that 350 g of triethylene glycol dimethacrylate were used instead of 250 g of epoxy resin. This gave a composition which comprised 25% by weight of particles.

### Example 3

500 g of an aqueous dispersion of highly crosslinked, resin-like, functional silicone particles were grafted with a copolymer composed of styrene, acrylic acid, and methyl methacrylate, and had an average particle size of 40 nm with a solids content of 18% by weight. 250 g of ethyl acetate were added and the material was heated to boiling point. 500 g of a 10% strength magnesium chloride solution were then added within a period of 30 minutes, and the mixture was cooled. The organic phase was isolated, and the solids content was determined (28% by weight). 150 g of a mixture composed of a bisphenol A diglycidyl ether and bisphenol F diglycidyl ether were then added. The solvent was then removed by distillation at boiling point. This gave a composition which comprised 37% by weight of core-shell particles, dispersed in the resin mixture.

### Example 4

As in Example 3, but a total of 3 aqueous dispersions of core-shell particles, each with a solids content of from 25-35% by weight, was used, the respective average particle size being 50 nm, 150 nm, and 400 nm, each separately having been extracted with methyl isobutyl ketone extractant. The respective organosols of strength from 24-28% were mixed with one another and treated with an aromatic epoxy resin. The solvent was removed by distillation at reduced pressure, giving a composition with 30% by weight of core-shell particles in 3 particle populations of different particle size.

### Example 5

625 g of an organosol of core-shell particles with an average particle size of 100 nm and with a solids content of 30% by weight, dissolved in butyl methyl ether, and prepared by the process of Example 3, were treated at room temperature with 375 g of a commercially available composition (Albidur, Hanse-Chemie) and with a further amount of epoxy resin, and stirred at 40° C. for 24 h, until the mixture had become homogeneous. The solvent was then removed by distillation at 80° C. and slightly reduced pressure. This gave a composition with 30% by weight particle content and with two different particle populations, one of these populations having a particle size of from 0.3 to 3 micrometers with broad particle size distribution.

### Example 6

An aqueous dispersion of core-shell particles with an elastomeric silicone core and with a grafted-on acrylate copolymer shell, and with an inner core composed of an acrylate copolymer, with a particle size of 350 nm and a bimodal particle size distribution, was precipitated via addition of a mixture composed of 60% by weight of methanol and 40% by weight of acetone. The precipitate was isolated by filtration, washed, and dried. This gave 200 g of solid. 300 g of an epoxy resin which is solid at room temperature formed an initial charge and was heated to 120° C., whereupon the resin melted and became a low-viscosity liquid. The solid, composed of the reversibly agglomerated core-shell particles, was added and dispersed, first for 6 h at 120° C. and then for 2 h at 140° C. with the aid of high shear forces, and the material was then filtered at 140° C. Cooling gave a solid, homogeneous composition which comprised 40% by weight of core-shell particles, substantially free from agglomerate.

### Example 7

As Example 6, but a liquid urethane resin was used instead of the solid epoxy resin. This gave a composition which comprised 22% by weight of core-shell particles, dispersed in the urethane resin.

### Example 8

As in Example 6, an aqueous dispersion of functional core-shell particles formed an initial charge, but these do not yet have any organopolymer shell, but merely have an internal core and a particle size of 250 nm, and a relatively broad particle size distribution, and the material is not precipitated in the form of a solid but is treated with 700 g of toluene, 40 g of methyl methacrylate, and 500 g of a 10% strength magnesium sulfate solution which also comprised some acetic acid. After stirring for 24 h, the aqueous phase was isolated, and the organic solution was filtered and repeatedly washed with water to remove the detergent from the suspension. This gave 800 g of an organosol with a solids content of 20% by weight. The organosol was treated with a small amount of a polymerization initiator. The mixture was then stirred for 24 h at 90° C. An acrylate resin mixture composed of 3 components and of a stabilizer was added, the stabilizer suppressing the polymerization of the acrylate resins. The remaining solvent was then removed by distillation, giving a composition composed of 35% by weight of core-shell particles, dispersed in an acrylate resin mixture.

1-7. (canceled)

8. A composition comprising:
core-shell particles having an organopolysiloxane core and a crosslinked or non-crosslinked organopolymer shell; and
one or more reactive resins.

9. The composition of claim 8 wherein the core-shell particles have a crosslinked or non-crosslinked organopolymer core.

10. The composition of claim 8 wherein the core-shell particles have additional siloxane-containing particles.

11. The composition of claim 8 wherein the core-shell particles have an average diameter from 5 to 400 nm.

12. The composition of claim 8 wherein the core-shell particles have an inner core.

13. The composition of claim 12 wherein the shell or the inner core comprise a grafted-on organopolymer of one or more monomers capable of free-radical polymerization.

14. The composition of claim 8 having a silicone content of the core-shell particles from 20 to 95% by weight.

15. The composition of claim 8 having a silicone content comprising organopolysiloxane.

16. The composition of claim 15 wherein the silicone content comprises:
from 0-10 units of the general formula (1):
[R₃SiO_{1/2}] (1),
from 0-90 units of the general formula (2):
[R₂SiO_{2/2}] (2),
from 0-100 units of the general formula (3):
[RSiO_{3/2}] (3),
from 0-50 units of the general formula (4):
[SiO_{4/2}] (4),
wherein:
R is hydrogen or identical or different monovalent SiC-bonded or substituted C₁-C₁₈-hydrocarbon radicals.

17. The composition of claim 16 wherein the total amount units (2) and (3) are at least 5% by weight based on the silicone content.

18. The composition of claim 8 wherein the one or more reactive resins comprise a resin selected from the group consisting of epoxy resins, phenolic resins, urethane resins, acrylate resins, and silicone resins.

19. A method for preparing a composition comprising:
core-shell particles having an organopolysiloxane core and a crosslinked or non-crosslinked organopolymer shell; and
one or more reactive resins, the method comprising:
a) adding at least one reactive resin to an organic solution of the core-shell particles; and
b) removing the solvent.

20. The method of claim 19 wherein the composition further comprises additional siloxane-containing particles.
